(19) United States
(12) Patent Application Publication
(10) Pub. No.: US 2008/0206413 A1
(43) Pub. Date: Aug. 28, 2008

(54) Low Trans Puff Pastry Composition, Method of Use and Puff Pastry Products

(75) Inventors: Jeffrey B. Fine, Livingston, NJ (US); Josipa M. Paska, Toronto, Ontario (CA); James F. Feeney, Milltown, NJ (US)

Correspondence Address: THADDIUS J. CARVIS, 102 NORTH KING STREET, LEESBURG, VA, 20176, US

(73) Assignee: AARHUSKARLSHAMN USA INC., Port Newark, NJ (US)

(21) Appl. No.: 11/916,633

(22) PCT Filed: Jun. 6, 2006
(86) PCT No.: PCT/US06/21796

§ 371 Date: Jan. 17, 2008

Related U.S. Application Data
(60) Provisional application No. 60/687,746, filed on Jun. 6, 2005.

(51) Int. Cl. A21D 10/00; A23D 9/00

(52) U.S. Cl. 426/297; 426/556; 426/607

(57) ABSTRACT

Disclosed are improvements in puff pastry preparation, which reduce, and preferably eliminate, trans unsaturated fatty acids by the use of a new puff pastry fat comprised principally of palm olein, which is preferably interesterified. The puffed pastry fats exhibit low levels of trans fatty acids. The puff pastry fats and products are highly functional without resort to high solids contents, hydrogenation or butter or other animal fats.

### BACKGROUND OF THE INVENTION

The present invention relates to puffed pastry fats with low levels of trans fatty acids. More particularly, the invention provides puff pastry fats and products which are highly functional without resort to high solids contents, hydrogenation or butter or other animal fats.

Puff pastry is always considered something special. Puff pastries are among the most delicious pastries and are enjoyed with both sweet and savory foods. They owe their light, delicate and flakey texture to their unique combination of fat and dough, which adds a characteristic and highly desirable organoleptic enhancement to virtually any meal or course. To date, successful formulations are based on fats with high solids contents. Butter, the traditional choice, and hydrogenated vegetable oils have been the two primary alternative routes to good puff pastry. It would be highly desirable to provide puff pastries without the use of either butter or vegetable fats having trans unsaturation caused by hydrogenation.

In a broad sense, puff pastry is prepared from a dough, which is layered with fat and repeatedly folded and rolled to form planar, parallel areas of fat disposed throughout. Upon baking, the layers of thinly rolled dough within the sheet separate into a multiplicity of separate baked layers. The baked pastry product is light and flakey. This texture is the result of laminating a suitable fat and dough by repeating the process of rolling, folding and rerolling until the fat and dough layers become extremely thin. In a traditional preparation of puff pastry, the dough with fat is turned six times to yield 729 theoretical layers. Variations on this procedure can also be effective. The properties of the fat are critical. If it is too soft, it will be absorbed into the dough, and the layers will fuse. If the fat is too hard, the dough will tear when it is rolled. In all, the fat must be highly functional in order to permit formation of the separate layers and maintain them through baking.

Depending upon the procedure employed to prepare the puff pastry dough, the layers of fat and dough within the sheet can extend over the entire, which is preferred, or only a portion of the total, surface area of the dough sheets used in the preparation. An important feature of puff pastry—its ability to rise and yield a crisp, light pastry characterized by a flaky structure of parallel, horizontal leaves or layers distinguishing it from short or other doughs—depends on the proper selection and use of fat. There is a need for a fat that is not based on butter or hydrogenated components but can, yet, provide the kind of texture that chefs and consumers expect when they hear the term “puff pastry”.

Variations on the traditional procedure have been made and can also produce successful puff pastry doughs. The industrial production of doughs of this type does not always conform to tradition. For example, in U.S. Pat. No. 3,151,987 to S. F. Colby, there is described a process comprising the extrusion of alternate dough and fat layers which are then rolled, cut, laminated and rolled again to prepare a dough sheet which preferably comprises about 400 substantially continuous layers of dough, separated from each other by fat layers. When a sheet of puff pastry dough is baked, it rises into a flaky, multi-layered product, and is ideal for use with suitable fillings to provide napoleons, turnovers, strudels, casserole covers, meat-filled pastries, and the like. And, in most applications, this desirable rising and flaking is obtained without the aid of yeast or chemical leaveners.

The rising and flaking achieved in puff pastry depends on the fat being suitably functional to utilize the vaporization of moisture and the expansion of entrapped air to create the separate layers. The fat must be capable of properly rolling in and maintaining separation of the layers. This is believed to be a primary factor in determining the quality of the puff pastry. See, for example, AIB Tech Bulletin, Vol. XX, No. 2, from the American Institute of Baking.

Butter is the traditional puff pastry fat but has been replaced with other fats. These fats have relatively flat SFC curves, with considerable solids at high temperatures and are partially hydrogenated to achieve the desired solids profile and stabilize the fats from oxidation. These butter substitutes typically contain considerable amounts of solid fats and are almost always supplemented with significant amounts of partially hydrogenated fats. The process for producing the partial hydrogenation will invariably cause a degree of geometric isomerization, yielding trans unsaturation. Non butter fats without trans unsaturation have not been identified as suitably functional for puff pastry applications.

The process of modifying the plastic properties of fats by partial hydrogenation has been criticized because the resulting fats are perceived as less healthy than the native vegetable oils having high cis unsaturation. Partial hydrogenation results in the formation of trans fatty acids, whereas most natural vegetable fats and oils contain only cis double bonds. A number of studies have investigated the effect of trans fatty acids on raising low-density lipoprotein serum cholesterol levels and lowering high density lipo-protein serum cholesterol levels in adults fed fats having these acids. See, for example, Mensink, R. P., and Katan, M. B., New Eng. Jour. Med. 323: 439-445 (1990). For a more recent review, see Hu, F. B., et al., Types of Dietary Fat and Risk of Coronary Heart Disease: A Critical Review, J. American College of Nutrition, Vol. 20, No. 1, 5-19 (2001). Hu, et al., review epidemiologic evidence and dietary intervention studies regarding the relationship between dietary fat intake and risk of CHD (coronary heart disease). The evidence provides reason for consumers to reduce consumption trans fatty acids.

In U.S. Pat. No. 2,442,537, Eckey describes puff pastry and suitable fats. He indicates that the best results with regard to the ability of the dough to raise or lift (he calls this property “spring”) are obtained when the shortening is not absorbed appreciably by the dough and remains as a distinct layer separating the layers of dough. The patent indicates that the fat must be plastic to permit rolling and even distribution. It is also indicated that prior to this development of using a specially formulated, partially hydrogenated and interesterified fat, all-vegetable puff pastry shortenings did not have a desirable combination of spring, workability, oxidation stability and freedom from waxiness. His solution started by partially hydrogenating vegetable oils of the semi-drying and drying oil classes having high saponification and iodine values. The resulting plastic fats were interesterified at low temperature. These fats achieved plasticity through hydrogenation, as is generally the case, and contain significant quantities of trans unsaturated fatty acids—a result that it would be desirable to avoid.

In “Soy Shortenings For Bakers”, Clyde E. Stauffer, Ph.D., writing for the American Soybean Association and the United Soybean Board, discusses baking shortenings in general and puff pastry shortenings in particular. He notes that a puff pastry shortening (or margarine) is firmer than an all purpose shortening. The all purpose shortening and the puff pastry shortening have Wiley melting points of 46° C. and 54° C., respectively. The SFC profile for the puff pastry shortening shows 11% solids at 40° C. and 7% at 45° C. The plasticity depends on increasing fat solids by hydrogenation, which produces trans unsaturation.

In W. T. Doerry, Laminated Dough Systems, pages 63 to 68, published by the American Baking Institute, describes roll-in fats for puff pastries. It is noted that most baking fats are designed to cream and, therefore, exhibit too little cohesiveness to maintain a continuous fat barrier between dough layers. The author states that it is “very important” that the fat phase of puff pastry shortening contains a relatively high solid fat content, e.g., 16% at 40° C. and changes only gradually in the temperature range of 50 to 92° C. It also points out that, while most of the fat is added as roll in fat, a minor portion can be added to the dough with the flour.

In R. D. O'Brien, Fats and Oils, second edition, CRC, 2003, puff pastry shortenings are discussed and a range of solids is given for the SFI values. Again, here, the amount of fat solids is high at 40° C., being in the range of from 17 to 24. We note that the older texts typically use the term SFI for solids fat index as determined by AOCS Official Method Cd 10-57, while the newer texts use the term SFC for solid fat content as determined by AOCS Official Method Cd 166-93.

The Malysian Palm Oil Board has published a Pocketbook of PALM OIL USES (T. P. Pantzaris, fifth edition, 2000), which discusses the various features and advantages of palm oil. The exemplified puff pastry margarine has an SFC of 13% at 40° C., with the solids being increased by hydrogenation, which produces trans fatty acids.

In yet another standard text (Bailey's Industrial Oil and Fat Products, Y. H. Hui, ed., fifth edition, Vol. 3) puff pastry fats are again described as having an SFI curve higher than all-purpose shortening. It is indicated that the SFI profile for puff pastry fats is “fairly flat” with solid levels of 40% or higher at 10° C. to about 20% at 33.3° C. A typical formula (page 340) shows 16±1 percent solids at 40° C.

In Lipid shortenings: a review (B. S. Ghorta, et al., Food Research International, 35 (2002) 1015-1-48), all shortening types, including puff pastry shortening, are reviewed. Consistent with the other references, the exemplary puff pastry shortenings have high solids, e.g., 15% at 37.8° C. They discuss preparation by blending lard and hydrogenated soybean oil and interesterifying the blend.

In a publication of the American Institute of Balking entitled “Puff Pastry Formulation And Processing”, the characteristics of roll-in and puff pastry fats are discussed. For each, the SFI is high at 40° C.: 14% for the roll-in fat and 17% for the puff pastry fat. And again, in one of their Technical Bulletins, entitled “Formulation and Production of Puff Pastries”, they describe puff pastry shortenings as having high melting points and exhibiting little change in SFC in the temperature range of interest.

Thus, the art has quite uniformly recognized that high fat solids contents are necessary for puff pastry and that these are effectively achieved by hydrogenation and/or the use of butter of other animal fat. Unfortunately, those based on vegetable oils, are hydrogenated and contain significant trans unsaturation and those based on animal fat present yet other concerns, including cholesterol content and saturated fat content.

There is a present need for puff pastry fats which are free or at least substantially free of trans fatty acids and, desirably, can be made from a single oil fraction without requiring hydrogenation.

### SUMMARY OF THE INVENTION

In view of the difficulties with the prior art, it is an object of the present invention to provide an improved puff pastry fat, which overcomes the problems and disadvantages of the prior art.

It is a principal object of the invention to provide a trans free puff pastry fat.

It is another object of the invention to enable successful preparation of puff pastries without the need for the high solid fat contents, hydrogenation or dairy of other animal fats, e.g., butter, as traditional and previously thought necessary.

It is another object of the invention to enable successful preparation of puff pastries while reducing, and preferably eliminating, the usual trans fatty acids without sacrificing the desired lift and flakiness associated with quality puff pastry.

It is yet another object of the invention to provide puff pastry fats containing less solid fats than proposed by the prior art.

These and other objects are accomplished by the present invention, which provides improved low trans and trans free puff pastry fats, compositions containing them and processes for their use in preparation of puff pastry, as well as the products improved by their use, including puff pastry, and it does so without the need for the high fat solids contents, hydrogenation or animal fats as previously thought necessary.

In one aspect, the invention provides an improved puffed pastry dough sheet comprising a plurality of alternating layers of a fat comprised principally of palm olein and dough comprised of flour and water. In some aspects, the fat is in the form of a water-in-oil emulsion. In others, the fat is interesterified. The fat preferably comprises interesterified palm olein, wherein at least a major amount of the palm olein has been randomized by interesterification. The fat can comprise a blend of interesterified palm olein and a minor amount of another fat.

In another aspect the invention provides an improved process for preparing puff pastry dough sheet comprising: applying a fat as described to a sheet of dough comprised of flour and water; folding the sheet of dough onto itself so that the fat is covered with dough to form a layered structure of the fat separating dough layers; rolling the folded dough having the fat applied to it; and again folding the sheet of dough and rolling a plurality of times to form a puff pastry dough sheet.

The products of these processes and the specific fat compositions and their preparation and uses in preferred forms also form important parts of the invention. It is surprising that the puff pastry fats of the invention can contain less solid fats than as proposed by the prior art.

Other details and preferred aspects will be described in the detailed description which follows.

### DETAILED DESCRIPTION OF THE INVENTION

The invention provides improvements in puff pastry preparation, which reduce, and preferably eliminate, trans unsaturated fatty acids by the use of a new puff pastry fat comprised principally of palm olein, which preferably has been interesterified in at least major part.

The terms “trans fatty acids” and “trans unsaturated fatty acids” as used in this description will mean the same thing, namely that the fatty acids discussed have an unsaturation wherein hydrogen substituents are on opposite sides of an associated double bond (trans configuration) as opposed to the cis configuration appearing in nature wherein these same hydrogen constituents would be on the same side. The presence of the trans fatty acids is the result of partial hydrogenation and can occur, due to the action of the hydrogenation catalyst, during the hydrogenation process at double bonds that are not saturated. It is an advantage of the invention that hydrogenated fats are not required and, therefore, the total elimination of trans unsaturation is preferred. The preferred products of the invention comprise at least a major proportion of interesterified palm olein, which can be blended with a minor amount of another suitable oil. It is a distinct advantage of the invention that a single botanical source can be employed without the need for complex blending and processing, but that blending and processing can be tolerated in minor amount. It is surprising that the puff pastry fats of the invention preferably contain less solid fats than as proposed by the prior art.

The puff pastry fat of the invention also compares favorably to butter in a number of regards. First of all, it is fully functional in making puff pastry that is flakey and has good rising characteristics. Also, it has less saturated fats, with butter typically exhibiting more than 60% saturated fat. And, it is cholesterol free and, because it does not contain dairy, can be made to be compliant with kosher pareve dietary rules. It can be a 100% vegetable fat alternative to butter, which is perceived by many as the current best solution to the no-trans imperative for puff pastry.

The invention provides improvements in puffed pastry preparation that are directly related to the discovery that a fat comprised principally of palm olein, preferably at least partially randomized, is a highly effective puff pastry roll-in shortening. This is surprising because, contrary to what could be gleaned from reading the prior art, it is a liquid to soft solid at ordinary temperatures. The physical characteristics of the palm olein and randomized palm olein are such that, without testing it, one would simply not see it as useful for this purpose. Palm olein is defined as the liquid fraction of palm oil after crystallization at controlled temperatures. For a more precise definition, see Bailey's Industrial Oil and Fat Products, Y. H. Hui, ed., fifth edition, Vol. 3, pages 326-327. It is consumed worldwide as a cooking oil and as a constituent of margarines and shortenings. It is also incorporated into fat blends used in the manufacture of a variety of food products as well as in home food preparation. To our knowledge it has not been proposed for puff pastry, which has required the use of fats having significant solids contents.

The physical characteristics of palm olein differ from those of palm oil. It is fully liquid in warm climate and has a narrow range of glycerides. The palm olein preferred for the invention is preferably interesterified under conditions of time and temperature effective to randomize the distribution of fatty acids. Preferably, at least 50%, e.g. more than 85%, of the palm olein will be randomized. In most cases the choice will be to interesterify all of the palm olein. It is an advantage of the invention that the palm olein, preferably randomized, can be the sole fat used in the preparation of puff pastry, but its most surprising feature is its functionality as a roll-in fat where it shows good rise and flakiness in the puff pastry.

Palm olein by itself will have very little trans unsaturation because it is a naturally occurring product and is not hydrogenated. However, while it may contain some trans fatty acids by the usual methods of analysis, it is preferably well under 1%. Preferred ranges for properties of randomly interesterified palm oleins of use in the invention are given below, and reasonable variations from these values by up to 25%, but preferably no more than 5% are effective if the base oil prior to interesterification meets the above definition of palm olein:

| Mettler drop point, | 105-110° F. |
|---|---|
| A.O.C.S. Method Cc 18-80 | |
| Free fatty acids | 0.1% Max, as oleic |
| Color red: | 5 Lovibond, max. |
| Peroxide value | 1 max. meg/kg |
| Iodine value | 45-65 |
| Trans | <5% |
| Saturated fat | 45-55% |

| Triglyceride CN | Weight percent |
|---|---|
| 48 | 9-13 |
| 50 | 28-34 |
| 52 | 34-40 |

| Solid Fat Content | %, weight |
|---|---|
| 10° C. | 50-56 |
| 20° C. | 28-34 |
| 30° C. | 11-17 |
| 40° C. | 3-9 |

The preparation of an interesterified puff pastry roll-in fat according to the invention can employ any interesterification procedure effective to provide randomization. In one preferred procedure, palm olein is interesterified by first drying the oil under vacuum while heating it to a temperature of about 80° C. A suitable catalyst such as sodium methoxide (0.2-0.4%) or any of those in common use, is then added. The reaction is desirably agitated under vacuum for approximately 30 minutes while being held at temperature. A notable change of oil color to dark brown will occur, which is characteristic of the reaction. The reaction can then be quenched by the addition of water and a suitable neutralizing agent, such as phosphoric acid. The oil phase can be separated from the aqueous phase and may be washed with water. The oil is preferably dried and then bleached and deodorized.

The puff pastry fat of the invention will be comprised principally of palm olein, and this is preferred. However, in some cases, it may be desirable to employ minor amounts of other fats. In some cases, it can be useful, while retaining the advantages of the invention, to employ from 1 to 20% of a vegetable oil or fraction, or other edible triglyceride such as a member selected from the group consisting of borage, Canola, carrot, corn, cottonseed, meadow foam, mustard seed, olive, palm, palm kernel, peanut, poppy seed, rice bran, rapeseed, high erucic rapeseed, soybean, safflower, sunflower, high oleic sunflower, sesame, evening primrose, and the like. Liquid triglycerides are preferred for blending according to the invention. Preferably, the puff pastry roll-in fat of the invention will comprise a blend of interesterified palm olein and another triglyceride oil derived from a member selected from the group consisting of Canola, palm, palm kernel, peanut, soybean, safflower, sunflower, high oleic sunflower and mixtures of two or more of these.

Where an addition of a minor amount of another, triglyceride is made, the blend is preferably done by simple blending, but the blend can be interesterified, preferably randomly, if that is desired. In some cases, it may be useful to randomize the added triglyceride prior to blending. Among the preferred products of the invention are those that contain a blend of randomly interesterified palm olein and a minor amount, e.g., less than 15%, more narrowly from about 2 to 8%, say about 4 to 6%, of an oil such as Canola oil, palm kernel oil and/or peanut oil.

If desired, the fat can be emulsified to form a water-in-oil emulsion. The amount of water can be any that will not adversely affect the ability of the fats of the invention to meet their main utility as puff pastry roll-in fat. The particular product applications will determine the amount of aqueous phase, if employed, but the amounts will typically be on the order of from 1 to 20%. The composition of the aqueous phase can be of the type used for margarines. To prepare a water-in-oil emulsion, like that of a margarine, separate oil and aqueous phases are prepared and then blended and emulsified together. The oil phase will contain, in addition to the palm olein and other fat described above, all other fat soluble components such as color, flavor and vitamins, emulsifiers, and/or crystal modifying agents. Typical emulsifiers will be mono- and di-glycerides and/or lecithin. Examples of coloring agents are beta-carotene, annatto, turmeric, paprika and FD&C dyes. Representative of the flavors will be lipolyzed butter oils, diacetyl, 2-octanone, butyric acid, hexanoic acid, and the like. The water phase may contain water-soluble flavors, and other water-soluble and dispersible materials such as milk or whey solids, preservatives, salt, casein, caseinates, albumins and other suitable margarine ingredients.

The preferred process for preparing puff pastry according to the invention can be summarized as comprising: applying a roll-in fat comprised principally of interesterified palm olein to a sheet of dough comprised of flour and water; folding the sheet of dough onto itself so that the palm olein is covered with dough to form a layered structure of palm olein separating dough layers; rolling the folded dough having the palm olein applied to it; again folding the sheet of dough and rolling a plurality of times to form a puff pastry dough sheet. The invention can employ the traditional folding and rolling procedure, wherein a dough mixture of flour and water is first formed and rolled flat. A portion approximating two thirds of the resulting rolled sheet is then coated with fat. The uncoated one third of the sheet is then folded onto the adjacent fat-coated third, and the remaining fat-coated third is folded over the top to form a composite having three layers of dough, separated by two layers of fat. This layered composite is then dusted with flour and rolled evenly to approximately the original size, it being important to maintain as uniform a thickness as possible. After rolling, excess flour is brushed off and the dough is again folded in three. Experienced bakers will understand the need to allow the dough to rest and will generally rest it between rollings for a time period of from about 15 to 20 minutes. Following each rolling, the dough is covered and maintained cool during the rest period, referred to by bakers as retarding the dough. This rolling, folding, and retarding is repeated several, typically 3 to 5, additional times before final rolling. There results a composite sheet of puff pastry dough which comprises a plurality of thin, substantially-continuous dough layers which are separated from each other by interposed layers of fat. The preferred products will comprise at least 250 dough layers, separated from each other by layers of fat.

The final results of this process for forming the puff pastry dough depend as much on the skill and experience of the person performing it as they do on the use of the correct ingredients; however, without a suitable puff pastry roll-in fat in the dough, the results will not be satisfactory. The roll-in fat will be employed at any effective level, e.g., at a level of from about 50 to 100% of the weight of the flour. Typically, the dough layers which make up the sheet comprise flour and water exclusively, but can contain other materials as are known to the art for their desired functions. Thus, flavors, fat, texture modifiers, and the like can be employed, but are not necessary. It is an advantage of the invention that the same fat used as the roll-in fat for layering can also be employed with the water and flour to form the dough, e.g., at a level of 5 to 20% of the flour. The flour will preferably be a high gluten content flour, because this enables the best elongation of the dough during rolling and results in best leavening due to natural expansion of gases during baking. To further improve this elongation characteristic, an acid such as cream of tartar, lemon juice, or vinegar can be employed. These added acids cause the protein, i.e., gluten, content of the flour to become more elastic, thus enabling it to stretch rather than break. Conversely, a less-elastic, more-tender dough can be prepared by adding fat or an amount of a low gluten flour. And, egg white will increase the leavening power of the dough by increasing its elasticity, while egg yolks add richness and color to the product.

The flour is preferably a hard winter wheat flour and is employed with water at a ratio of flour-to-water within the range of from about 3:2 to about 3:1, with a ratio of about 2:1 being preferred. Where eggs are employed, they add significant amounts of moisture, and the amount of free water added can be reduced accordingly. Again, it must be stressed that the skill and experience of the baker is extremely important and the final proportions must be altered as necessary to obtain the desired texture. The fat is important, not only for its functional effects on layering and subsequent rising ability, but also for its organoleptic contribution. Accordingly, fat contents of from 20 to 60% based on the total weight of the puff pastry dough are typical. Preferably, fat contents of from 35 to 50% on this same basis will be employed.

The puff pastry doughs prepared according to the invention can be cut, stored and baked as with those currently available. Typically, baking will be accomplished by placing in an oven at a temperature of from 375 to 425° C. for from about 15 to about 25 minutes, at which time they should have achieved significant lift and a light golden brown color. The skilled baker will be able to adjust conditions of time, temperature and finish color as dictated by ingredients and use.

The following examples are presented to further explain and illustrate the invention and are not to be taken as limiting in any regard. Unless otherwise indicated, all parts and percentages are by weight here as in the above description. These examples demonstrate that the invention provides improvements in puff pastry fats, which enable the production of high quality puff pastry products without the need for the high solids contents, hydrogenation or animal fats as taught generally to the art.

### COMPARATIVE EXAMPLE 1

This example describes the comparison in baking for a commercial fat and a series of experimental low trans fats made to have SFC profiles designed to meet the literature's call for high solids contents to make them suitable for puff pastry. However, they were made with various oils and fractions having little or no trans unsaturation in an attempt to achieve the objective of finding a trans free puff pastry fat.

Blends were made from the blends as follows:

| | Commercial | A | B | C | D |
|---|---|---|---|---|---|
| Part. hydrogenated SBO | X | | | | |
| Part. hydrogenated CSO | X | | | | |
| Interesterified Palm Olein | | X | X | | |
| Palm Hard fraction | | X | X | X | X |
| Palm Kernel Oil | | | X | X | |
| Palm Oil | | | | | X |
| Mono & Di Glycerides | X | | | | |
| Water | X | | | | |
| Art. color | X | | | | |

A number of test puff pastries are prepared with fats described above. The procedures for preparing the pastries and their evaluation are carefully controlled to maintain the same conditions for the preparation and testing of all samples.

For each fat, sheets of puff pastry dough are prepared by blending and mixing the following ingredients:

| Ingredient | Bakers %¹ |
|---|---|
| Wheat flour | 100 |
| Dough shortening | 15 |
| Cream of tarter | 0.75 |
| Liquid whole eggs | 10 |
| Ice water | 51 |
| Roll in shortening | 85 |

¹Based on weight of flour

The dough for each test is formed into a rectangular sheet about 5 mm thick. The roll in fat is then applied over two thirds of the sheet, and the one third not spread with fat is then folded over onto the middle third of the sheet. The other end is then folded over towards the middle to result in three layers of dough separated by two layers of fat. This layered composite is then dusted with flour and rolled evenly to approximately the original size. The excess flour is brushed off and the dough is again folded in three. The dough is covered and maintained cool and is permitted to rest for about 15 to 20 minutes. This rolling, folding, and resting is repeated 4 additional times before final rolling. Following final rolling, the dough sheets are cut into 3×3 inch squares and baked in a Reed oven at 400° C. for 25 minutes. All samples for comparison are baked for the same period of time.

The baked puffed pastries are then tested for rise by stacking six high and measuring the height of the stack, which we call lift in the table below. The results for the various fats tested are shown in the table below.

| | Commercial | A | B | C | D |
|---|---|---|---|---|---|
| Lift, cm | 26.2 | 13 | 17.5 | 13 | 11.5 |
| Color | Typical | OK | OK | Pale | Pale, uneven |
| Pass | Yes | No | No | No | No |

Based on these tests, the search for a reduced trans puff pastry roll-in fat other than butter did not look promising.

### EXAMPLE 1

This example describes the preparation of a puff pastry fat according to the invention. A palm olein is interesterified by first drying the oil under vacuum while heating it to a temperature of 80° C. Sodium methoxide (approximated at 0.3%) is then added. The reaction is agitated under vacuum fro approximately 30 minutes while being held at temperature. A notable change of oil color to dark brown is characteristic of the reaction. The reaction is quenched by the addition of water and phosphoric acid. The oil phase is separated from the aqueous phase and may be washed with water. The oil is dried and is then bleached and deodorized. A randomly interesterified palm olein exhibiting the following properties results:

| Property | Value |
|---|---|
| Mettler drop point, | 108° F. |
| A.O.C.S. Method Cc 18-80 | |
| Free fatty acids | 0.05% Max, as oleic |
| Color red: | 3.5 Lovibond, max. |
| Peroxide value | 1 max. meg/kg |
| Iodine value | 55 |
| Trans | <1% |
| Saturated fat | 50% |

| Triglyceride Carbon Number | Weight % |
|---|---|
| 48 | 11 |
| 50 | 31 |
| 52 | 37 |

| Solid Fat Content | %, weight |
|---|---|
| 10° C. | 53 |
| 20° C. | 31 |
| 30° C. | 14 |
| 40° C. | 6 |

### EXAMPLE 2

A randomized palm olein having the following properties is used to prepare puff pastry, which is compared to puff pastry made by the same procedure, but with the commercially available puff pastry shortening used in Comparative Example 1.

| | Example 1 | |
|---|---|---|
| Solid Fat Content | Weight % Solids | Commercial |
| 10° C. | 52 | 52 |
| 20° C. | 30 | 38 |
| 30° C. | 12 | 24 |
| 40° C. | 5 | 11 |

Trans fatty acid content, wt. %

| Example 1 | Commercial |
|---|---|
| <1 | 32 |

Puff pastry doughs were prepared and evaluated as in Comparative Example 1, with the following results:

| | Example 1 | Commercial |
|---|---|---|
| Lift, cm | 26.2 | 26.2 |
| Color | Typical | Typical |
| Pass | Yes | Yes |

### EXAMPLE 3

A randomized palm olein as described in Example 1 was blended with palm kernel oil and Canola oil at a weight ratio of 93/03/02 to form a Blended Fat. The Blended Fat was used in baking as in Example 2, with comparison to the Example 1 Fat of the invention and the Commercial Fat of Comparative Example 1, with the following results:

| | Example 1 Fat | Commercial Fat | Blended Fat |
|---|---|---|---|
| Lift, cm | 36 | 32 | 30 |
| Color | Typical | Typical | Typical |
| Pass | Yes | Yes | Yes |

The above description is intended to enable the person skilled in the art to practice the invention. It is not intended to detail all of the possible modifications and variations which will become apparent to the skilled worker upon reading the description. It is intended, however, that all such modifications and variations be included within the scope of the invention which is seen in the above description and otherwise defined by the following claims. The claims are meant to cover the indicated elements and steps in any arrangement or sequence which is effective to meet the objectives intended for the invention, unless the context specifically indicates the contrary.

1. An improved puffed pastry dough sheet comprising a plurality of alternating layers of a fat comprised principally of palm olein and dough comprised of flour and water.

2. An improved puff pastry dough sheet according to claim 1 wherein the palm olein is interesterified.

3. An improved puff pastry dough sheet according to claim 1 wherein the fat comprises interesterified palm olein blended with 1 to 20% by weight of another triglyceride.

4. An improved puff pastry dough sheet according to claim 4 wherein the fat comprises interesterified palm olein blended with 2 to 8% by weight of a liquid triglyceride oil.

5. An improved puff pastry dough sheet according to claim 1 wherein the fat is in the form of a water-in-oil emulsion.

6. An improved puff pastry dough sheet according to claim 5 wherein the fat comprises a blend of interesterified palm olein and another triglyceride oil derived from a member selected from the group consisting of Canola, palm, palm kernel, peanut, soybean, safflower, sunflower, high oleic sunflower and mixtures of two or more of these.

7. An improved process for preparing a puff pastry dough sheet comprising:
applying a fat as described in claim 1 to a sheet of dough comprised of flour and water;
folding the sheet of dough onto itself so that the palm olein is covered with dough to form a layered structure of palm olein separating dough layers;
rolling the folded dough having the palm olein applied to it;
